(19) United States
(12) Patent Application Publication
(10) Pub. No.: US 2022/0237137 A1
(43) Pub. Date: Jul. 28, 2022

(54) PIPELINE SETTING SELECTION FOR GRAPH-BASED APPLICATIONS

(71) Applicant: TEXAS INSTRUMENTS INCORPORATED, Dallas, TX (US)

(72) Inventors: Lucas Weaver, Dallas, TX (US); Jesse Gregory Villarreal, JR., Richardson, TX (US)

(21) Appl. No.: 17/582,992

(22) Filed: Jan. 24, 2022

Related U.S. Application Data
(60) Provisional application No. 63/140,649, filed on Jan. 22, 2021.

(51) Int. Cl. G06F 13/40; G06F 13/16

(52) U.S. Cl. CPC G06F 13/4027; G06F 13/1673

(57) ABSTRACT

An example system includes a pipeline depth determination circuit and a buffer depth determination circuit. The pipeline depth determination circuit is configured to analyze input-output connections between a plurality of processing nodes specified to perform a processing task, and determine a pipeline depth of the processing task based on the input-output connections. The buffer depth determination circuit is configured to analyze the input-output connections between the plurality of processing nodes, and assign, based on the input-output connections, a depth value to each of a plurality of buffer memories configured to store output of a first of the processing nodes for input to a second of the processing nodes.

### CROSS-REFERENCE TO RELATED APPLICATIONS

This application claims priority to U.S. Provisional Application No. 63/140,649, filed Jan. 22, 2021, entitled Automated Pipeline Settings for Graph-Based Applications in Heterogeneous SoC's, which is hereby incorporated by reference.

### BACKGROUND

In a computer processing system, multiple distinct processing functions may need to be executed on data according to a defined data processing flow, with the output(s) of one function providing the input(s) for the next function. To improve the throughput of the processing system, at any given time, each of the processing functions may be applied to a different data set, or different sub-set of a data set. Such simultaneous or overlapped processing by the various processing functions is referred to as pipelining.

### SUMMARY

In one example, a system includes a pipeline depth determination circuit and a buffer depth determination circuit. The pipeline depth determination circuit is configured to analyze input-output connections between a plurality of processing nodes specified to perform a processing task, and determine a pipeline depth of the processing task based on the input-output connections. The buffer depth determination circuit is configured to analyze the input-output connections between the plurality of processing nodes, and assign, based on the input-output connections, a depth value to each of a plurality of buffer memories configured to store output of a first of the processing nodes for input to a second of the processing nodes.

In another example, a non-transitory computer-readable medium is encoded with instructions that, when executed, cause a processor to identify input-output connections between a plurality of processing nodes specified to perform a processing task. The instructions also cause the processor to determine a pipeline depth of the processing task based on the input-output connections. The instructions further cause the processor to assign, based on the input-output connections, a depth value to each of a plurality of buffer memories configured to store output of a first of the processing nodes for input to a second of the processing nodes.

In a further example, a method includes identifying, by a processor, input-output connections between a plurality of processing nodes specified to perform a processing task. The method also includes determining, by the processor, a pipeline depth of the processing task based on the input-output connections. The method further includes assigning, by the processor, based on the input-output connections, a depth value to each of a plurality of buffer memories configured to store output of a first of the processing nodes for input to a second of the processing nodes.

### BRIEF DESCRIPTION OF THE DRAWINGS

For a detailed description of various examples, reference will now be made to the accompanying drawings in which:

FIG. 1A illustrates an example graph for execution by a heterogeneous computing system.

FIG. 1B shows an example of the graph of FIG. 1 adapted for pipelined execution by a heterogeneous computing system.

FIG. 2 shows an example of assignment of pipeline depth values to the nodes of a graph.

FIG. 3 shows an example of assignment of pipeline depth values to the nodes of a graph with awareness of the computational resource assigned to each node.

FIGS. 4 and 5 show example assignment of buffer depth value to inter-node buffers in a graph.

FIGS. 6 and 7 show example assignment of buffer depth values to inter-node buffers in a graph, where nodes are executed by a same computational resource.

FIG. 8 shows a block diagram for an example heterogeneous computing system suitable for executing a pipelined graph application.

FIG. 9 is a flow diagram of a method for determining and assigning a pipeline depth value and buffer depth values to a graph to be executed using pipelining in a heterogeneous computing system.

FIG. 10 is a flow diagram of a method for determining and assigning a pipeline depth value to a graph to be executed using pipelining in a heterogeneous computing system.

FIG. 11 is a flow diagram of a method for determining and assigning buffer depth values to a graph to be executed using pipelining in a heterogeneous computing system.

FIG. 12 is block diagram of an example processor platform suitable for use in determining and assigning a pipeline depth value and buffer depth values to a graph to be executed using pipelining in a heterogeneous computing system.

The same reference number is used in the drawings for the same or similar (either by function and/or structure) features.

### DETAILED DESCRIPTION

In various types of computing applications (e.g., video, imaging, or vision computing applications), a data processing flow may be represented as a connected graph with the processing nodes (nodes) of the graph representing the processing functions to be executed. Thus, the terms “processing node,” “functional node,” and, more succinctly, “node” may be used to refer to a processing function to be implemented. A heterogeneous computing system, such as a heterogeneous System-on-Chip (SoC), includes a variety of computational resources, such as general-purpose processor cores, digital signal processor (DSP) cores, and function accelerator cores, that may be applied to implement specified processing functions (e.g., to execute the nodes of a graph). To improve throughput of a processing flow, the nodes may be operated as stages of a pipeline. For example, the nodes may be implemented using separate and distinct computational resources, such that the nodes of a processing flow process different portions of a dataset in an overlapped fashion.

To implement pipelined processing based on a graph, for example graph pipelining in accordance with the OpenVX Graph Pipelining Extension, the depth of the pipeline (pipeline depth) and the depth of buffers (buffer depth) provided between pipeline stages must be determined. Pipeline depth and buffer depth are not defined as part of the graph itself. In some graph implementations, these parameters are determined manually as part of the development cycle of the processing flow. Manual selection of these pipeline parameters requires access to expertise and additional development time. For example, selection of optimum pipeline parameters may require multiple cycles of trial and error even with access to graph analysis expertise.

The pipeline processing techniques disclosed herein automatically select values of pipeline depth and buffer depth in a target device, such as a heterogeneous SoC, by analyzing the graph to be executed. Thus, the pipelining manager of the present disclosure determines pipeline parameters without developer assistance while reducing development time and expense. The selected pipeline parameters may also improve the efficiency of computational resource and memory utilization.

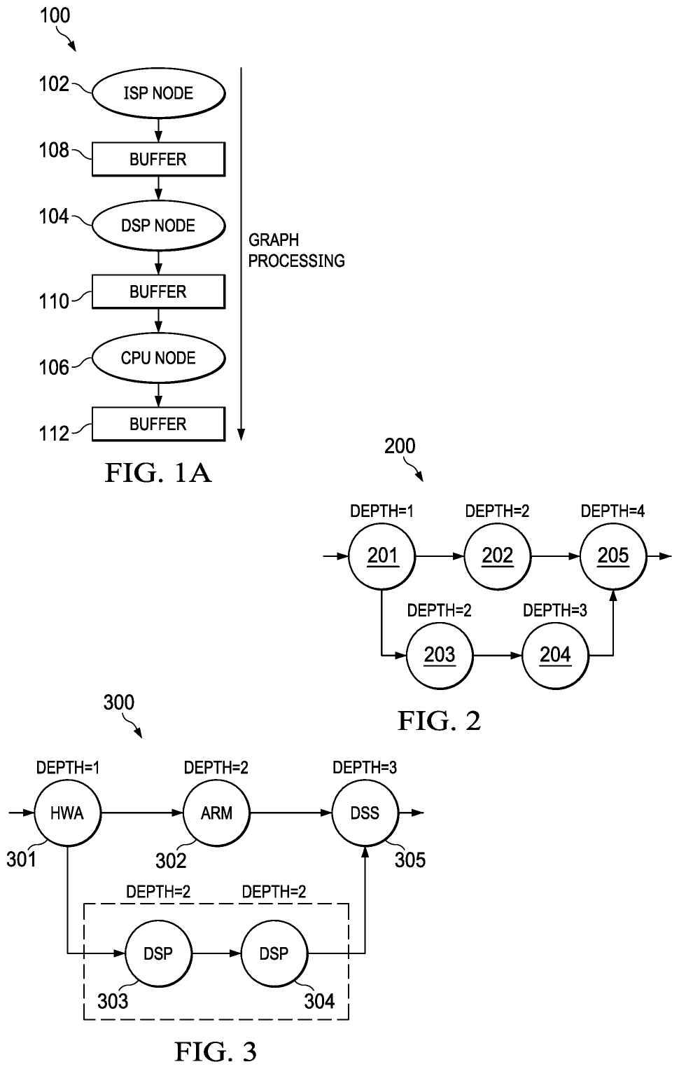

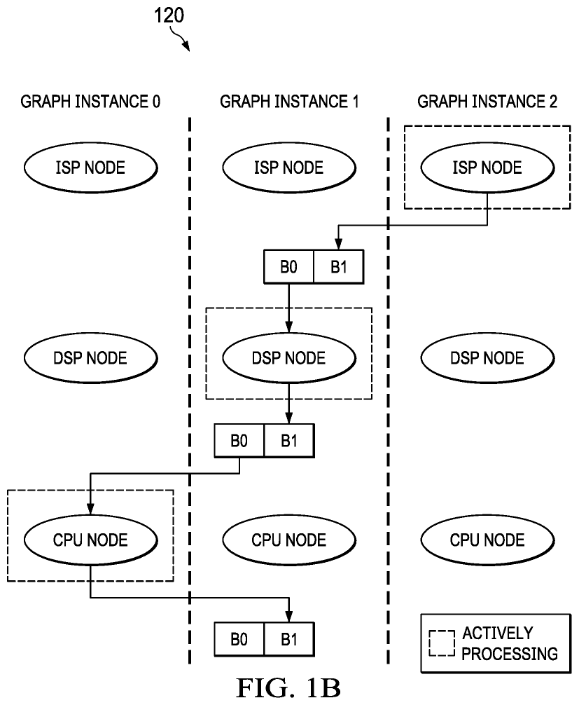

FIG. 1A illustrates an example graph 100 for execution by a heterogeneous computing system, such as a heterogeneous SoC. The graph 100 includes nodes 102, 104, and 106 that define the processing task to be performed, and buffers 108, 110, and buffer 112 (buffer memories) that store output of a node (e.g., for input to another node). The graph 100 is implemented using three computational resources (e.g., three different processing cores) of the heterogeneous computing system. The node 102 is executed on an image signal processor (ISP) core, the node 104 is executed on a DSP core, and the node 106 is executed on a central processing unit (CPU) core. Thus, each node of the graph 100 is executed by a different computational resource of the heterogeneous computing system.

The buffer 108 (buffer memory) stores output of the node 102 for input to the node 104. The buffer 110 stores output of the node 104 for input to the node 106. The buffer 112 stores output of the node 106 for input to systems external to the graph 100.

If the graph 100 is executed without pipelining, a new execution of the graph 100 is unable to start until the prior execution of the graph 100 is complete. However, because the computational resources assigned to the nodes of the graph 100 can operate concurrently, the graph 100 is inefficient with regard to hardware utilization and throughput.

Pipelining the graph 100 allows for more efficient use of hardware by creating multiple instances of the graph based on the value of the pipeline depth. FIG. 1B shows an example pipelined graph 120 that adapts the graph 100 for pipelined execution. In the graph 100, the optimal pipeline depth is three. With a pipeline depth of three, a graph processing framework treats the pipelined graph 120 as if there were 3 instances of the graph 100 processing simultaneously as shown in FIG. 1B. FIG. 1B also shows the buffers accessed by the nodes have been assigned a depth of 2 to allow for continuous transfer of data between the nodes. Pipeline depth and buffer depth are not defined by the graph 100. Pipeline depth and buffer depth are automatically determined using the pipeline depth and buffer depth procedures disclosed herein.

FIG. 2 shows an example of pipeline depth values assigned to the nodes of graph 200. The graph 200 includes nodes 201, 202, 203, 204, and 205. The output of node 201 is processed by nodes 202 and 203. The output of node 202 is processed by node 205. The output of node 202 is also processed by node 204. The output of node 204 is processed by node 205. In one example procedure for determined pipeline depth, pipeline depth is determined based on structure of the graph, without considering the computational resources assigned to the nodes. Pipeline depth routine 1 illustrates an example software-based implementation of pipeline depth determination based on graph structure.

PIPELINE DEPTH ROUTINE 1

| | |
|---|---|
| 1 | /* Perform a sort of the nodes within graph */ |
| 2 | TopologicalSortGraphNodes (context, nodes); |
| 3 | |
| 4 | /* Loop through sorted nodes in graph. |
| 5 | * Note: Prior to calling this logic, node − >node_depth has |
| 6 | * been initialized to 1 * |
| 7 | while( GetNextNode (context, &node) != 0 ) |
| 8 | { |
| 9 | / * Set depth for each node based on the nodes that precede it */ |
| 10 | for (input_node_idx=0; |
| 11 | input_node_idx < GetNumberInputNodes (node); |
| 12 | input_node_idx++) |
| 13 | { |
| 14 | prev_node = GetInputNode (cur_node, input_node_idx); |
| 15 | if (node − >node_depth <= prev_node − >node_depth) |
| 16 | { |
| 17 | node − >node_depth = prev_node − >node_depth + 1; |
| 18 | } |
| 19 | } |
| 20 | } |

At line 2 of pipeline depth routine 1, a topological sort of the nodes of a graph is executed. In lines 5-18 of pipeline depth routine 1, using the sorted nodes, a depth value is assigned to each node. The depth value assigned to a given node is selected based on the number of nodes preceding the given node (e.g., a count of the number of nodes present in a path to the given node). The pipeline depth of the graph is selected to be the highest depth value assigned to a node of the graph.

Applying the pipeline depth determination of pipeline depth routine 1 to the graph 200, node 201 is assigned a depth value of one. Nodes 202 and 203 are assigned a depth value of two. Node 204 is assigned a depth value of three. Node 205 is assigned a depth value of four. The pipeline depth of the graph 200 based on the structure of the graph 200 is set to four.

FIG. 3 shows an example of pipeline depth values assigned to the nodes of a graph 300 with an awareness of the computational resource assigned to each node. The graph 300 is structurally identical to the graph 200. In the graph 300, the node 301 is executed by a hardware accelerator, the node 302 is executed by a CPU (e.g., an ARM core), nodes 303 and 304 are executed by a same DSP core, and node 305 is executed by a display sub-system. In the graph 300, pipeline depth is determined based on structure of the graph, while considering the computational resources assigned to the nodes. Pipeline depth routine 2 illustrates an example software-based implementation of pipeline depth determination based on graph structure and awareness of computational resource assignments.

PIPELINE DEPTH ROUTINE 2

| | |
|---|---|
| 1 | /* Perform a sort of the nodes within graph*/ |
| 2 | TopologicalSortGraphNodes (context, nodes); |
| 3 | |
| 4 | /* Loop through sorted nodes in graph |
| 5 | * Note: Prior to calling this logic, node − >node_depth |
| 6 | * has been initialized to 1 */ |
| 7 | while( GetNextNode (context, &node ) != 0 ) |
| 8 | { |
| 9 | /* Set depth for each node based on the nodes that precede it */ |
| 10 | for (input_node_idx=0; |
| 11 | input_node_idx < GetNumberlnputNodes (node ); |
| 12 | input_node_idx++) |
| 13 | { |
| 14 | prev_node = GetlnputNode (cur_node, input_node_idx ); |
| 15 | if (node − >node_depth <= prev_node − >node_depth ) |
| 16 | { |
| 17 | /* Determine whether this target exists in the |
| 18 | * sequence preceding this node */ |
| 19 | if (!isTargetlnNodeSequence (node − >target, prev_node)) |
| 20 | { |
| 21 | node − >node_depth = prev_node − >node_depth + 1; |
| 22 | node.addTargetSequence (prev_node ); |
| 23 | } |
| 24 | else |
| 25 | { |
| 26 | node−>node_depth = prev_node − >node_depth; |
| 27 | } |
| 28 | } |
| 29 | } |
| 30 | } |

At line 2 of pipeline depth routine 2, a topological sort of the nodes of a graph is executed. In lines 7-24 of pipeline depth routine 2, a depth value is assigned to node. If the computation resource assigned to a given node is not assigned to the node preceding a given node, then the depth of the given node is the depth of the preceding node plus one. If the computation resource assigned to the given node is also assigned to the node preceding the given node, then the depth of the given node is the same as the depth of the preceding node (a same depth value is assigned to the nodes). The pipeline depth of the graph is selected to be the highest depth value assigned to a node of the graph.

Applying the pipeline depth determination of pipeline depth routine 2 to the graph 300, node 301 is assigned a depth value of one. Nodes 302, 303, and 304 are assigned a depth value of two. Node 305 is assigned a depth value of three. The pipeline depth of the graph 300 based on the structure of the graph 300 and the computational resources assigned to the nodes is set to three.

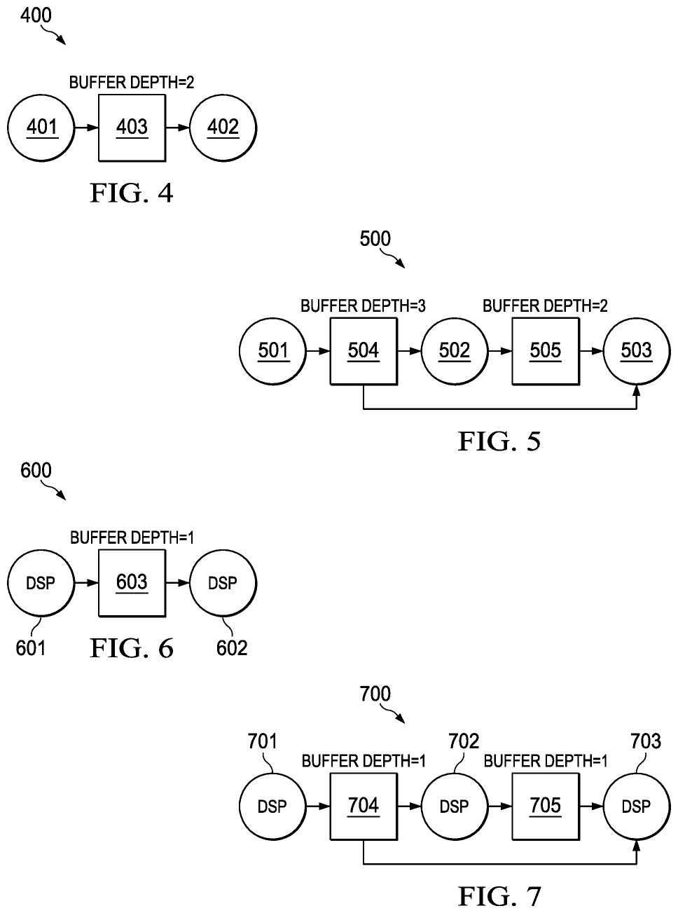

FIGS. 4 and 5 show example buffer depth value assignments for inter-node buffers in a graph. FIG. 4 shows an example that includes a node 401, a node 402, and a buffer 403. Buffer 403 stores output of the node 401 for input by the node 402. FIG. 5 shows an example graph 500 that include a node 501, a node 502, a node 503, a buffer 504, and a buffer 505. Buffer 504 stores output of the node 501 for input by the node 502 and the node 503. Buffer 505 stores output of the node 502 for input to the node 503.

In one example procedure for determining buffer depth, buffer depth is determined based on structure of the graph, without considering the computational resources assigned to the nodes. Buffer depth routine 1 illustrates a software-based implementation of buffer depth determination based on graph structure.

BUFFER DEPTH ROUTINE 1

| | |
|---|---|
| 1 | /* Looping through all nodes in graph */ |
| 2 | BufferDepthRoutinel (graph ) |
| 3 | { |
| 4 | for (node_idx=0; |
| 5 | node_idx<graph − >num_nodes; |
| 6 | node_idx++) |
| 7 | { |
| 8 | node = graph − >nodes[node_idx]; |
| 9 | |
| 10 | /* Looping through all parameters of node , |
| 11 | * looking for output parameters*/ |
| 12 | for (prm_cur_idx=0; |
| 13 | prm_cur_idx<ownNodeGetNumParameters(node); |
| 14 | prm_cur_idx++) |
| 15 | { |
| 16 | node direction= GetNodeDirection(node, prm_cur_idx); |
| 17 | |
| 18 | /* Only setting output parameters of nodes */ |
| 19 | if( node_direction = = OUTPUT ) |
| 20 | { |
| 21 | param = GetNodeOutputParameter(node, prm_cur_idx); |
| 22 | param − >num_buf = 1; |
| 23 | |
| 24 | /* MaxParamCascadeDepth returns the maximum number |
| 25 | * of cascading node connect ions to this param. |
| 26 | * If there are no cascading connect ions , this |
| 27 | * will return “1”, giving it a simple double |
| 28 | * buffering scheme */ |
| 29 | param − >num_buf += MaxParamCascadeDepth (param) |
| 30 | } |
| 31 | } |
| 32 | } |
| 33 | } |

Buffer depth routine 1 sets the depth of each buffer storing output of a given node to one greater than the number of nodes processing the output of the given node. For each node, buffer depth routine 1 identifies an output of the node, and identifies all other nodes that process the output of the node (receive the output of the node as input data). The depth of the buffer receiving the output of the node is initially set to one and incremented with each other node identified as processing the output of the node.

Applying the buffer depth determination of buffer depth routine 1 to the graph 400, the depth of buffer 403 is set to two, allowing a first buffer instance to receive output from the node 401, while a second buffer instance provides previously stored output of node 401 to node 402. Applying the buffer depth determination of buffer depth routine 1 to the graph 500, the depth of buffer 504 is set to three and the depth of buffer 505 is set to two.

FIGS. 6 and 7 show example buffer depth value assignments for inter-node buffers in a graph with an awareness of the computational resource assigned to each node. FIG. 6 shows an example graph 600 that includes a node 601, a node 602, and a buffer 603. Buffer 603 stores output of the node 601 for input by the node 602. In the graph 600, node 601 and node 602 are executed by a same DSP. FIG. 7 shows an example graph 700 that include a node 701, a node 702, a node 703, a buffer 704, and a buffer 705. Buffer 704 stores output of the node 701 for input by the nodes 702 and 703. Buffer 705 stores output of the node 702 for input to the node 703. In the graph 700, nodes 701, 702, and 703 are executed by a same DSP.

In the graph 600 and the graph 700, pipeline depth is determined based on structure of the graph, while considering the computational resources assigned to the nodes. Buffer depth routine 2 illustrates an example software-based implementation of buffer depth determination based on graph structure and awareness of computational resource assignments.

BUFFER DEPTH ROUTINE 2

| | |
|---|---|
| 1 | /* Looping through all nodes in graph */ |
| 2 | for(node_idx=0; |
| 3 | node_idx<graph − >num_nodes; |
| 4 | node_idx++) |
| 5 | { |
| 6 | node= graph − >nodes[node_idx]; |
| 7 | |
| 8 | /* Looping through all parameters of node, |
| 9 | * looking for output parameters */ |
| 10 | for (prm_cur_idx=0; |
| 11 | prm_cur_idx<ownNodeGetNumParameters(node); |
| 12 | prm_cur_idx++) |
| 13 | { |
| 14 | node direction= GetNodeDirection(node, prm_cur_idx); |
| 15 | |
| 16 | /* Only setting out put parameters of nodes */ |
| 17 | if( node_direction = = OUTPUT) |
| 18 | { |
| 19 | param = GetNodeOutputParameter(node, prm_cur_idx); |
| 20 | param − >num_buf = 1; |
| 21 | |
| 22 | /* Only setting out put parameters of nodes */ |
| 23 | if( node direction = = OUTPUT ) |
| 24 | { |
| 25 | param = GetNodeOutputParameter(node, prm_cur_idx); |
| 26 | param − >num_buf = 1; |
| 27 | |
| 28 | / * MaxParamCascadeDepthTarget returns the maximum |
| 29 | * number of cascading node connections to this param |
| 30 | * when taking the node target into account. |
| 31 | * If the connect ed or cascading nodes are on the same |
| 32 | * target as “node”, then this function returns “0” and no |
| 33 | * additional buffering beyond the single buffer is required |
| 34 | * Otherwise, this function will return the maximum number |
| 35 | * of cascading node connections to this param. */ |
| 36 | param − >num_buf += MaxParamCascadeDepthTarget(param, node − >target); |
| 37 | } |
| 38 | } |
| 39 | } |
| 40 | } |

Buffer depth routine 2 sets the depth of each buffer storing output of a given node to one greater than the number of nodes processing the output of the given node that are not executed by the same computational resource as the given node. For each node, buffer depth routine 2 identifies an output of the node, initializes the depth of the buffer receiving output to one, identifies all other nodes that process the output using a different computing resource than the node, and increments the buffer depth for each node receiving output from the buffer that does not use the same computing resource as the node writing to the buffer. Thus, the depth of the buffer set to one plus the number of nodes reading the buffer that use a different computational resource than the node writing the buffer.

Applying the buffer depth determination of buffer depth routine 2 to the graph 600, the depth of buffer 603 is set to one because nodes 701 and 702 are executed by the same DSP. Applying the buffer depth determination of buffer depth routine 2 to the graph 700, the depth of buffer 704 is set to one and the depth of buffer 705 is set to one because nodes 701, 702, and 703 are executed by the same DSP. Thus, buffer depth routine 2 reduces the amount of memory allocated to the buffers when the same computational resource is applied to serially execute the nodes.

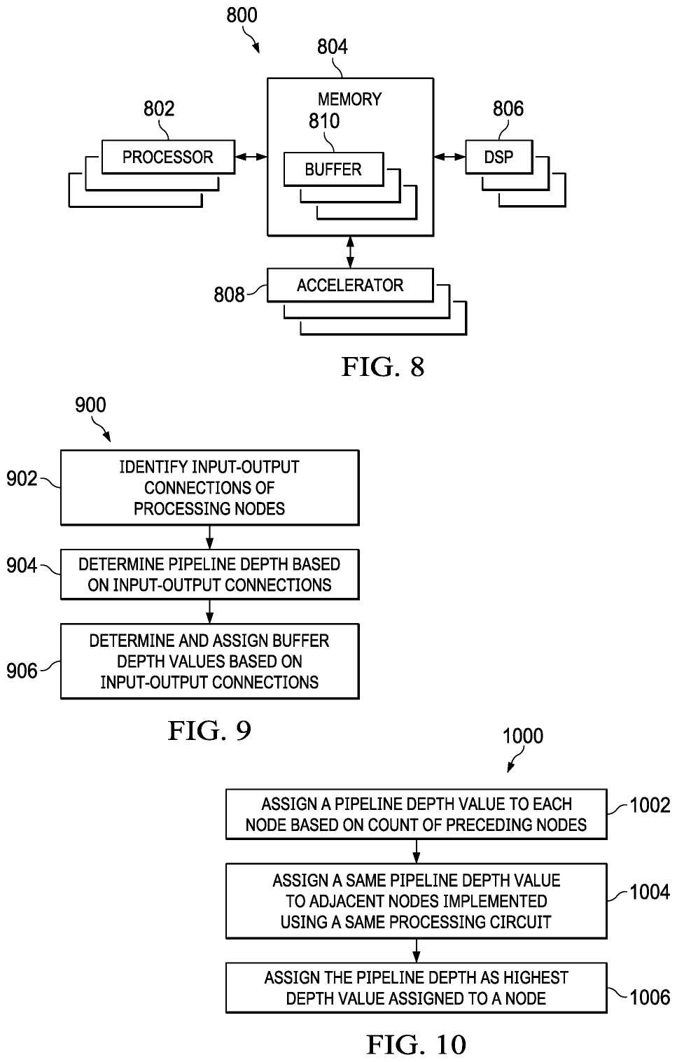

FIG. 8 shows a block diagram for an example heterogeneous computing system 800 suitable for executing a pipelined graph application. The heterogeneous computing system 800 may be a heterogeneous SoC. The heterogeneous computing system 800 includes processor(s) 802, memory 804, DSP(s) 806, and accelerator(s) 808 (hardware accelerators). The processor(s) 802 may include general-purpose microprocessor cores. The memory 804 is coupled to the processor(s) 802, the DSP(s) 806, and the accelerator(s) 808. Each node of a pipelined graph is assigned to be executed by the processor(s) 802, the DSP(s) 806, or the accelerator(s) 808. Portions of the memory 804 form the buffers 810 that store the data transferred between the processor(s) 802, the DSP(s) 806, and the accelerator(s) 808, that is, the data transferred between the nodes of the pipelined graph. For example, referring to the graph 300, node 301 may be executed on a first hardware accelerator of the accelerator(s) 808, node 3022 may be executed on a CPU of the processor(s) 802, nodes 303 and 304 may be executed on a DSP core of the DSP(s) 806, and node 305 may be executed on an accelerator of the accelerator(s) 808. Other examples of a heterogeneous computing system may include more, less, and/or different computational resources than the heterogeneous computing system 800.

FIG. 9 is a flow diagram of a method 900 for determining and assigning a pipeline depth value and buffer depth values for a graph to be executed using pipelining in a heterogeneous computing system. Though depicted sequentially as a matter of convenience, at least some of the actions shown can be performed in a different order and/or performed in parallel. Additionally, some implementations may perform only some of the actions shown.

In block 902, a graph to be executed has been downloaded to a heterogeneous computing system, such as the heterogeneous computing system 800. The heterogeneous computing system is configured to execute the graph using pipelining to increase throughput and computing resource utilization. To implement pipelining of the graph, the heterogeneous computing system determines a value of pipeline depth for the graph, and determines a value of buffer depth for each buffer applied to store node output.

To determine the pipeline and buffer depth values, the heterogeneous computing system analyzes the nodes of the graph, and identifies the input-output connections of the nodes. For example, the heterogeneous computing system determines a sequence of nodes connected from graph start to graph end for assigning pipeline depth, and determines, for each node, which other nodes process the output of the node for assigning buffer depth.

In block 904, the heterogeneous computing system determines a pipeline depth value based on the interconnection of the nodes between graph start and end. The method 1000 illustrated in FIG. 10 provides additional detail regarding determination of pipeline depth.

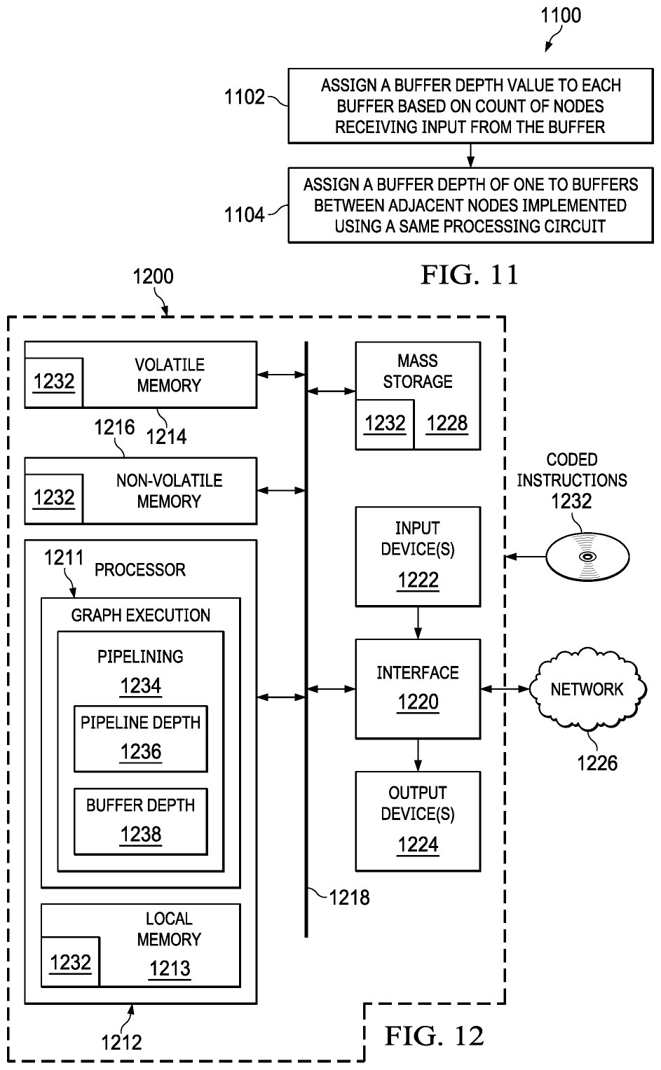

In block 906, the heterogeneous computing system determines buffer depth values based on the input-output connections the nodes, and assigns the buffer depth values to the buffers that store output of the nodes. The method 1100 illustrated in FIG. 11 provides additional detail regarding determination of buffer depth values.

The pipelined graph is initialized using the assigned pipeline depth and buffer depth values, and executed by the heterogeneous computing system.

FIG. 10 is a flow diagram of a method 1000 for determining and assigning a pipeline depth value for a graph to be executed using pipelining in a heterogeneous computing system. Though depicted sequentially as a matter of convenience, at least some of the actions shown can be performed in a different order and/or performed in parallel. Additionally, some implementations may perform only some of the actions shown. Operations of the method 1000 may be performed as part of operations of block 904 of the method 900.

In block 1002, the heterogeneous computing system assigns a pipeline depth value to each node of the graph based on the number of preceding nodes (the number of other nodes connected between the start of the graph and the node).

In block 1004, the heterogeneous computing system identifies the computing resource (the processing circuit) assigned to each node. If two adjacent nodes are implemented using the same computing resource, a same pipeline depth value is assigned to the two adjacent nodes.

In block 1006, the pipeline depth value is set to be a highest node depth value assigned to a node of the graph in block 1004. In some implementation of the method 1000, the pipeline depth value is set to be a highest node depth value assigned to a node of the graph in block 1002.

FIG. 11 is a flow diagram of a method 1100 for determining and assigning buffer depth values for a graph to be executed using pipelining in a heterogeneous computing system. Though depicted sequentially as a matter of convenience, at least some of the actions shown can be performed in a different order and/or performed in parallel. Additionally, some implementations may perform only some of the actions shown. Operations of the method 1100 may be performed as part of operations of block 906 of the method 900.

In block 1102, the heterogeneous computing system assigns, to each buffer receiving output from a node of the graph, a buffer depth value. The buffer depth value is based on a count of nodes that receive input from the buffer. E.g., a count of nodes that process the output of a given node, where the buffer stores the output of the given node. The assigned buffer depth value may be one plus the number of nodes receiving input from the buffer in some implementations.

In block 1104, the heterogeneous computing system identifies adjacent nodes that are to be implemented using a same computing resource (adjacent nodes executed by the same computing resource). Because the processing done by adjacent nodes executed by the same computing resource must be serialized, a buffer depth of one may be assigned to a buffer between such nodes.

FIG. 12 is block diagram of an example processor platform 1200 suitable for use in determining and assigning a pipeline depth value and buffer depth values for a graph to be executed using pipelining in a heterogeneous computing system. The processor platform 1200 can be, for example, embedded in a heterogeneous computing system, such as a heterogeneous SoC.

The processor platform 1200 includes a processor 1212. The processor 1212 of the illustrated example is hardware. For example, the processor 1212 can be implemented by one or more integrated circuits, logic circuits, microprocessors, or controllers. The processor 1212 may be a semiconductor based (e.g., silicon based) device. The processor 1212 executes instructions for implementing a graph execution framework 1211 that includes a pipelining manager 1234 that configures the heterogeneous computing system to pipeline execution of a graph. The pipelining manager 1234 includes a pipeline depth determination circuit 1236 that determines a pipeline depth for the graph as described herein, and buffer depth determination circuit 1238 that assigns depth values to the buffer associated with the graph as described herein. The pipeline depth determination circuit 1236 and the buffer depth determination circuit 1238 are formed by execution of the coded instructions 1232 by the processor 1212.

The processor 1212 includes a local memory 1213 (e.g., a cache). The processor 1212 is in communication with a main memory including a volatile memory 1214 and a nonvolatile memory 1216 via a link 1218. The link 1218 may be implemented by a bus, one or more point-to-point connections, etc., or a combination thereof. The volatile memory 1214 may be implemented by Synchronous Dynamic Random Access Memory (SD RAM), Dynamic Random Access Memory (DRAM), RAMBUS Dynamic Random Access Memory (RD RAM), Static Random Access Memory (SRAM), and/or any other type of random access memory device. The nonvolatile memory 1216 may be implemented by flash memory and/or any other desired type of memory device. Access to the main memory may be controlled by a memory controller.

The processor platform 1200 may also include an interface circuit 1220. The interface circuit 1220 may be implemented according to any type of interface standard, such as an Ethernet interface, a universal serial bus (USB), and/or a PCI express interface.

One or more input devices 1222 may be connected to the interface circuit 1220. The one or more input devices 1222 permit a user to enter data and commands into the processor 1212. The input device(s) can be implemented by, for example, an audio sensor, a microphone, a camera (still or video), a keyboard, a button, a mouse, a touchscreen, a track-pad, a trackball, a voice recognition system and/or any other human-machine interface. Also, many systems, such as the processor platform 1200, can allow the user to control the computer system and provide data to the computer using physical gestures, such as, but not limited to, hand or body movements, facial expressions, and face recognition.

One or more output devices 1224 may also be connected to the interface circuit 1220. The output devices 1224 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 may include a graphics driver device, such as a graphics card, a graphics driver chip, or a graphics driver processor.

The interface circuit 1220 may also include a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 may also include one or more mass storage devices 1228 for storing software and/or data. Examples of mass storage devices 1228 include floppy disk drives, hard drive disks, compact disk drives, Blu-ray disk drives, RAID (redundant array of independent disks) systems, and digital versatile disk (DVD) drives.

Coded instructions 1232 corresponding to the instructions of pipeline depth routine 1, pipeline depth routine 2, buffer depth routine 1, and/or buffer depth routine 2 may be stored in the mass storage device 1228, in the volatile memory 1214, in the nonvolatile memory 1216, in the local memory 1213 and/or on a removable tangible computer readable storage medium, such as a CD or DVD. The processor 1212 executes the instructions as part of the pipeline depth determination circuit 1236 or the buffer depth determination circuit 1238.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement.

Modifications are possible in the described embodiments, and other embodiments are possible, within the scope of the claims.

What is claimed is:

1. A system, comprising:
a pipeline depth determination circuit configured to:
analyze input-output connections between a plurality of processing nodes specified to perform a processing task; and
determine a pipeline depth of the processing task based on the input-output connections;
a buffer depth determination circuit configured to:
analyze the input-output connections between the plurality of processing nodes; and
assign, based on the input-output connections, a depth value to each of a plurality of buffer memories configured to store output of a first of the processing nodes for input to a second of the processing nodes.

2. The system of claim 1, wherein the pipeline depth determination circuit is configured to assign a depth value to each processing node based on a count of the processing nodes present in a path to the processing node.

3. The system of claim 2, wherein the pipeline depth determination circuit is configured to assign the pipeline depth to be a highest depth value assigned to the processing nodes.

4. The system of claim 2, wherein the pipeline depth determination circuit is configured to:
identify a first of the processing nodes implemented using a first processing circuit;
identify a second of the processing nodes configured to process an output of the first of the processing nodes, and implemented using the first processing circuit; and
assign a same depth value to the first of the processing nodes and the second of the processing nodes.

5. The system of claim 1, wherein the buffer depth determination circuit is configured to assign a buffer depth value to each buffer memory of the buffer memories based on a count of the processing nodes configured to receive input data from the buffer memory.

6. The system of claim 5, wherein the buffer depth value is greater than the count of the processing nodes configured to receive input data from the buffer memory.

7. The system of claim 1, wherein the buffer depth determination circuit is configured to:
identify a first of the processing nodes implemented using a first processing circuit;
identify a second of the processing nodes configured to process an output of the first of the processing nodes, and implemented using the first processing circuit; and
assign a buffer depth value to one of the buffer memories configured to pass data from the first of the processing nodes to the second of the processing nodes based on the first of the processing nodes and the second of the processing nodes being implemented using the first processing circuit.

8. The system of claim 7, wherein the buffer depth value is one.

9. A non-transitory computer-readable medium encoded with instructions that, when executed, cause a processor to:
identify input-output connections between a plurality of processing nodes specified to perform a processing task;
determine a pipeline depth of the processing task based on the input-output connections; and
assign, based on the input-output connections, a depth value to each of a plurality of buffer memories configured to store output of a first of the processing nodes for input to a second of the processing nodes.

10. The non-transitory computer-readable medium of claim 9, wherein the instructions, when executed, cause the processor to assign a depth value to each processing node based on a count of the processing nodes present in a path to the processing node.

11. The non-transitory computer-readable medium of claim 10, wherein the instructions, when executed, cause the processor to assign the pipeline depth to be a highest depth value assigned to the processing nodes.

12. The non-transitory computer-readable medium of claim 10, wherein the instructions, when executed, cause the processor to:
identify a first of the processing nodes implemented using a first processing circuit;
identify a second of the processing nodes configured to process an output of the first of the processing nodes, and implemented using the first processing circuit; and
assign a same depth value to the first of the processing nodes and the second of the processing nodes.

13. The non-transitory computer-readable medium of claim 9, wherein the instructions, when executed, cause the processor to assign a buffer depth value to each buffer memory of the buffer memories based on a count of the processing nodes configured to receive input data from the buffer memory.

14. The non-transitory computer-readable medium of claim 13, wherein the buffer depth value is greater than the count of the processing nodes configured to receive input data from the buffer memory.

15. The non-transitory computer-readable medium of claim 9, wherein the instructions, when executed, cause the processor to:
identify a first of the processing nodes implemented using a first processing circuit;
identify a second of the processing nodes configured to process an output of the first of the processing nodes, and implemented using the first processing circuit; and
assign a buffer depth value to one of the buffer memories configured to pass data from the first of the processing nodes to the second of the processing nodes based on the first of the processing nodes and the second of the processing nodes being implemented using the first processing circuit.

16. The non-transitory computer-readable medium of claim 13, wherein the buffer depth value is one.

17. A method, comprising:
identifying, by a processor, input-output connections between a plurality of processing nodes specified to perform a processing task;
determining, by the processor, a pipeline depth of the processing task based on the input-output connections; and
assigning, by the processor, based on the input-output connections, a depth value to each of a plurality of buffer memories configured to store output of a first of the processing nodes for input to a second of the processing nodes.

18. The method of claim 17, further comprising assigning, by the processor, a depth value to each processing node based on a count of the processing nodes present in a path to the processing node.

19. The method of claim 18, further comprising assigning, by the processor, the pipeline depth to be a highest depth value assigned to the processing nodes.

20. The method of claim 18, further comprising:
identifying, by the processor, a first of the processing nodes implemented using a first processing circuit;
identifying, by the processor, a second of the processing nodes configured to process an output of the first of the processing nodes, and implemented using the first processing circuit; and
assigning, by the processor, a same depth value to the first of the processing nodes and the second of the processing nodes.

21. The method of claim 17, further comprising assigning, by the processor, a buffer depth value to each buffer memory of the buffer memories based on a count of the processing nodes configured to receive input data from the buffer memory.

22. The method of claim 17, further comprising:
identifying, by the processor, a first of the processing nodes implemented using a first processing circuit;
identifying, by the processor, a second of the processing nodes configured to process an output of the first of the processing nodes, and implemented using the first processing circuit; and
assigning, by the processor, a buffer depth value to one of the buffer memories configured to pass data from the first of the processing nodes to the second of the processing nodes based on the first of the processing nodes and the second of the processing nodes being implemented using the first processing circuit.
